(19) United States
(12) Patent Application Publication
(10) Pub. No.: US 2002/0101998 A1
(43) Pub. Date: Aug. 1, 2002

(54) Fast escrow delivery

(76) Inventors: Chee-Hong Wong, Singapore (SG); Kok-Hoon Teo, Singapore (SG); See-Wai Yip, Singapore (SG); Kok-Khuan Fong, Singapore (SG); Eng-Whatt Toh, Singapore (SG)

Correspondence Address: FENWICK & WEST LLP, TWO PALO ALTO SQUARE, PALO ALTO, CA, 94306, US

(21) Appl. No.: 09/881,899

(22) Filed: Jun. 14, 2001

Related U.S. Application Data
(63) Continuation-in-part of application No. 09/332,358, filed on Jun. 10, 1999.
(60) Provisional application No. 60/242,014, filed on Oct. 19, 2000.

(51) Int. Cl. H04L 9/00

(52) U.S. Cl. 380/286; 713/153

(57) ABSTRACT

A system, method and computer readable medium for securely transmitting an information package (10) to an addressee (190) via a network (108), wherein an addressee (190) is not required to have a private-public key pair before the package (10) is sent. A sending system (102) encrypts the package (10) with a package encryption key (600) and then encrypts a package decryption key (601) with an escrow encryption key (380) obtained from an escrow key manager (116). The encrypted package (10) and encrypted package decryption key (601) are held in escrow by a server system (104), until the addressee (190) is issued a new public and private key pair (390, 391). The server system (104) decrypts the package decryption key (601), re-encrypts it with the addressee's new public key (390), and forwards the encrypted package (10) and re-encrypted package decryption key (601) to the addressee's receiving system (106). The receiving system (106) receives the delivery and decrypts the information package (10).

### CROSS-REFERENCES TO RELATED APPLICATIONS

This invention is a continuation-in-part of, and claims priority upon, commonly-assigned U.S. patent application Ser. No. 09/332,358, “SIMPLIFIED ADDRESSING FOR PRIVATE COMMUNICATIONS,” by Eng-Whatt Toh and Peng-Toh Sim, filed Jun. 10, 1999.

This application also claims the benefit of U.S. Provisional Patent Application Serial No. 60/242,014, “METHOD FOR FAST ESCROW DELIVERY,” by Chee-Hong Wong, Kok-Hoon Teo, See-Wai Yip and Eng-Whatt Toh, filed Oct. 19, 2000.

The subject matter of all of the foregoing is incorporated, in their entirety, herein by reference.

### BACKGROUND OF THE INVENTION

1. Technical Field

The present invention relates generally to cryptographic communications, and more particularly, to a system and method for transmitting an encrypted message via an escrow agent.

2. Description of Background Art

In symmetric key cryptography, both the sender and receiver of a message use the same secret key. The sender uses the secret key to encrypt the message and the receiver uses the same secret key to decrypt the message. However, a difficulty arises when the sender and receiver attempt to agree on the secret key without anyone else finding out. For example, if the sender and receiver are in separate physical locations, they must trust a courier, a telephone system, or some other transmission medium to prevent the disclosure of the secret key. Anyone who overhears or intercepts the key in transit can later read, modify, and forge all messages encrypted or authenticated with that key. Thus, symmetric key encryption systems present a difficult problem of key management.

Public key cryptography was developed as a solution to the key management problem. In public key cryptography, two keys are used a public key and a private key. The public key is published, while the private key is kept secret. Although the public and private keys are mathematically related, neither can be feasibly derived from the other.

To send a private message using public key cryptography, a message is encrypted using the recipient's public key, which is freely available, and decrypted using recipient's private key, which only the recipient knows. Thus, the need for the sender and recipient to share secret information is eliminated. A sender needs to know only the recipient's public key, and no private keys are ever transmitted or shared.

Public key cryptography has another advantage over symmetric key cryptography in the ability to create digital signatures. One of the significant problems in cryptography is determining whether an encrypted message was forged or modified during transmission. As noted above, if a symmetric key is lost or stolen, any person in possession of the key can create forged messages or modify legitimate messages.

Using public key cryptography, however, a sender can digitally “sign” a message using the sender's private key. Thereafter, the recipient uses the sender's public key to verify that the message was actually sent by the sender and was not modified during transmission. Thus, a recipient can be confident that a message was actually sent by a particular sender and was not modified during transmission.

Despite its many advantages, public key cryptography presents three basic difficulties. First, in order to send private messages, the sender must know beforehand the public key of the recipient. Conventional public key systems typically rely on a sender's locally-maintained address book of public keys. Thus, if the recipient's public key is not in the sender's address book, the sender must somehow contact the recipient by telephone or e-mail, for example, to request the recipient's public key. Such systems are cumbersome and inconvenient, and prevent widespread adoption and use of public key cryptography.

More fundamentally, another problem with public key cryptography is that a recipient must first have a public key in order to receive an encrypted message. Because the technology is relatively new, only a few users have currently obtained public keys. This fact alone represents a significant barrier to adoption because a sender cannot encrypt a message to the recipient until the recipient has completed the process of obtaining a public key.

Yet another problem with public key cryptography is the relative ease for “spoofing” a public key. In other words, a first user may publish his public key in the name of a second user and thereby receive private communications intended for the second user. Various solutions, such as digital certificates and certificate authorities (CA's), have been proposed to address this problem, but are not relevant to present application.

Accordingly, what is needed is a system and method for securely transmitting an information package using public key cryptography in which the sender is not required to know the recipient's public key before the package is sent. Indeed, what is needed is a system and method for securely transmitting an information package using public key cryptography in which the recipient is not required to have a public key before the package is sent.

### DISCLOSURE OF INVENTION

According to the invention, a computer-implemented system, methods, and computer-readable medium for securely transmitting an information package (10) from a sender (180) to an addressee (190) via a network (108) includes the following. A server system (104) performs the steps of receiving a delivery from the sender (180) and storing it in escrow. The delivery includes the information package (10) encrypted with a package encryption key (600) and a package decryption key (601) encrypted with an escrow key (380), if the addressee's public key is not available. The server system (104) sends a notification of the delivery to the addressee (190). In response to receiving an acknowledgement from the addressee (190), the server system (104) obtains a new public key (390) of the addressee (190), decrypts the package decryption key (601), re-encrypts the package decryption key (601) with the addressee's new public key (390), and transmits the encrypted information package (10) and the re-encrypted package decryption key (601) to the addressee (190).

The present invention can also include the sending system (102) providing a digital signature, a message digest, and/or a digitally signed message digest as part of the delivery. Inclusion of one or more of these items helps the receiving system (106) verify the origin and integrity of the delivery.

Using the present invention, a sender is not required to know the addressee's public key before a package (10) is sent. Indeed, the addressee (190) is not required to have a public key before the package (10) is sent. If an addressee public key is available, then it will be used to encrypt the package decryption key (601) to maximize security; but if one is not available at the time of send, then the package decryption key (601) is encrypted using the escrow encryption key (380). This process ensures that sender (180) is not required to wait for the availability of the addressee public key before a delivery can be sent. If the addressee (190) does not currently have a public key, the addressee (190) will be issued new public (390) and private keys (391), so the addressee (190) can be authenticated and receive the delivery. The package decryption key (601) is re-encrypted before delivery to the addressee (190) to ensure only the addressee (190) can open it. Regardless, the public key (390) presented by the addressee (190) for receipt of the delivery will be stored for future reference such that subsequent private communications may be encrypted using the addressee's public key (390). Thus, the present invention removes significant barriers to adoption of public key cryptography, while increasing the security of private communications.

### BRIEF DESCRIPTION OF THE DRAWINGS

These and other more detailed and specific objects and features of the present invention are more fully disclosed in the following specification, reference being had to the accompanying drawings, in which

FIG. 1 is a functional block diagram of a secure communications system for transmitting information packages according to an embodiment of the present invention;

FIG. 2 is a physical block diagram showing additional implementation details of a sending system according to an embodiment of the present invention;

FIG. 3 is a flow diagram of a secure communication system according to an embodiment of the present invention;

FIG. 4 is a flow diagram of a first embodiment of a transmission module (122) and a decryption module (126) according to an embodiment of the present invention;

FIG. 5 is a flow diagram of a second embodiment of a transmission module (122) and a decryption module (126) according to an embodiment of the present invention;

FIG. 6A is a flow diagram of a secure communication system according to an embodiment of the present invention;

FIG. 6B is a flow diagram of an embodiment of a transmission module (122) and a decryption module (126) according to an embodiment of the present invention;

FIG. 7 is a flow diagram of an embodiment of a transmission module (122) and a decryption module (126) according to an embodiment of the present invention, wherein the delivery includes a signed digest; and

FIG. 8 is a flow diagram of an embodiment of a transmission module (122) and a decryption module (126) according to an embodiment of the present invention, wherein the delivery includes an alternate signed digest.

### DETAILED DESCRIPTION OF THE PREFERRED EMBODIMENTS

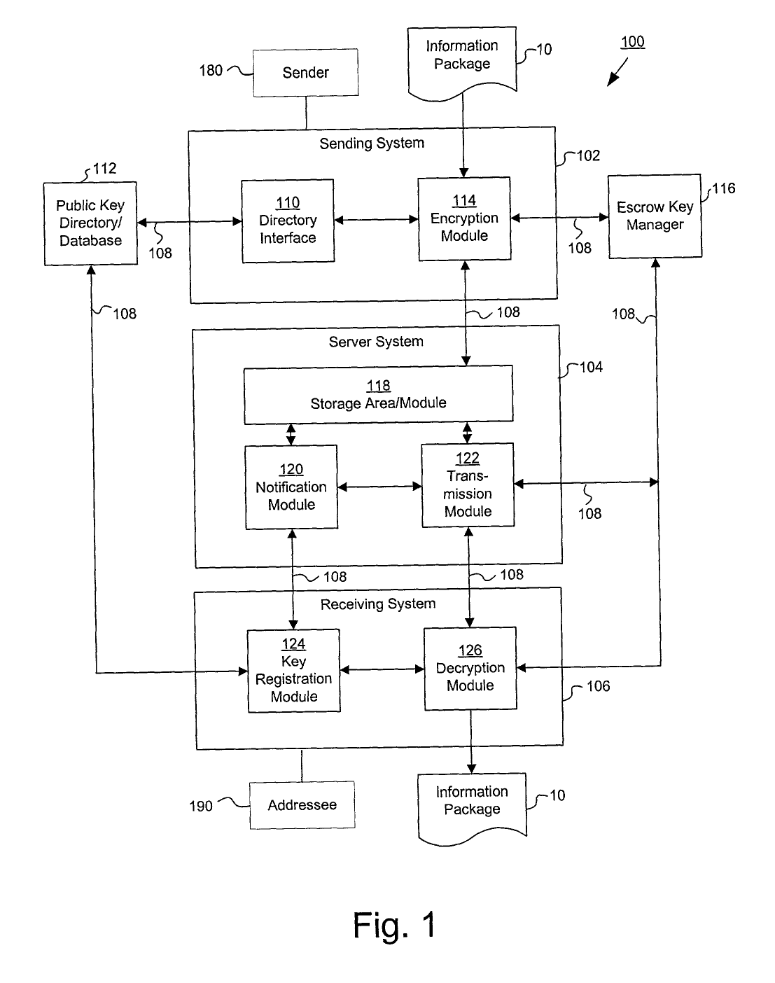

A preferred embodiment of the invention is now described with reference to the Figures, where like reference numbers indicate identical or functionally similar elements. Also in the Figures, the left most digit of each reference number corresponds to the Figure in which the reference number is first used. Referring now to FIG. 1, there is shown a functional block diagram of a secure communications system 100 for transmitting information packages 10 according to an embodiment of the present invention.

The principal components of the system 100 include a sending system 102, a server system 104, and a receiving system 106. The sending system 102 is coupled to the server system 104, and the server system 104 is coupled to the receiving system 106, via an “open” computer network 108, such as the Internet. Preferably, all transmissions over the network 108 are by a secure protocol, such as the Secure Multipurpose Internet Mail Extension (S/MIME), the Secure Sockets Layer (SSL) Protocol, and/or by a Virtual Private Network (VPN).

The sending system 102 is used by a sender 180 to securely transmit an information package 10 to at least one intended “recipient,” who is interchangeably referred to herein as an “addressee” 190. It will be noted that “sender” 180 can usually be interchanged for “sending system” 102 and that “addressee” 190 can usually be interchanged for “receiving system” 106. Sender 180 and addressee 190 can represent individuals and entities. It will also be noted that there may be a one-to-one, one-to-many, and many-to-one relationship between sender 180 and sending system 102 and between addressee 190 and receiving system 106.

In one embodiment, the sending system 102 includes a directory interface 110 for communicating via the network 108 with an external public key directory 112. The directory 112 is a database of the public keys of registered addressees and may be selectively queried to determine the public key of each addressee 190 of the information package 10. Preferably, the directory 112 may be queried using the addressee's e-mail address.

In one embodiment, the public key directory 112 is implemented using an existing online directory infrastructure provided, for example, by VeriSign, Inc. of Mountain View, Calif. In alternative embodiments, however, the directory is implemented using a conventional database system, such as one available from SyBase, Inc., of Emeryville, Calif., although other databases could be used without departing from the spirit of the invention. Preferably, the directory 112 is accessed by the directory interface 110 using the Lightweight Directory Access Protocol (LDAP).

The sending system 102 also includes an encryption module 114 for encrypting information packages 10. The encryption module 114 is coupled to receive an escrow encryption key 380 from an escrow key manager 116 or a public key 390 from the directory interface 110, as described in greater detail below. Preferably, the encryption module 114 uses a public key cryptosystem, available, for example, from RSA Security, Inc., of San Mateo, Calif. In alternative embodiments, however, a symmetric key algorithm, such as the Data Encryption Standard (DES), is used. Preferably, each encrypted package 10 conforms to the S/MIME standard, which is well known to those skilled in the art. In addition, key lengths of at least 128 bits (in the case of symmetric key cryptography) are preferably used to provide a high level of data security.

The escrow key manager 116 generates keys and/or provides stored keys for use in encrypting and decrypting information packages 10 to be stored in escrow. In one embodiment, the escrow key manager 116 is a process running on a separate escrow key management server (not shown), and the encryption module 114 communicates with the escrow key manager 116 via the network 108. Alternatively, the escrow key manager 112 is a functional unit contained within one or more of the sending system 102, the server system 104, or the receiving system 106.

The encryption module 114 is coupled via the network 108 to a storage area 118 within the server system 104. In one embodiment, the storage area 118 is a database for storing encrypted information packages and is managed, for example, by a SyBase database system. Once encrypted, an information package 10 is sent using a protocol, such as the Hypertext Transfer Protocol (HTTP) or VPN tunnels, to be stored within the storage area 118 pending notification and authentication of the addressee. In alternative embodiments, however, the storage area 118 is contained within the sending system 102, and packages 10 are stored locally until an addressee 190 is notified and properly authenticated.

The server system 104 additionally includes a notification module 120 for sending a notification of the package 10 to an addressee 190 at the receiving system 106. In one embodiment, the notification is an e-mail message, and the notification module 120 is an e-mail server, such as the Microsoft Exchange® Server 5.5 or Exchange 2000, available from Microsoft Corporation of Redmond, Wash., although those skilled in the art will recognize that other notification systems and methods could be used within the scope of the present invention.

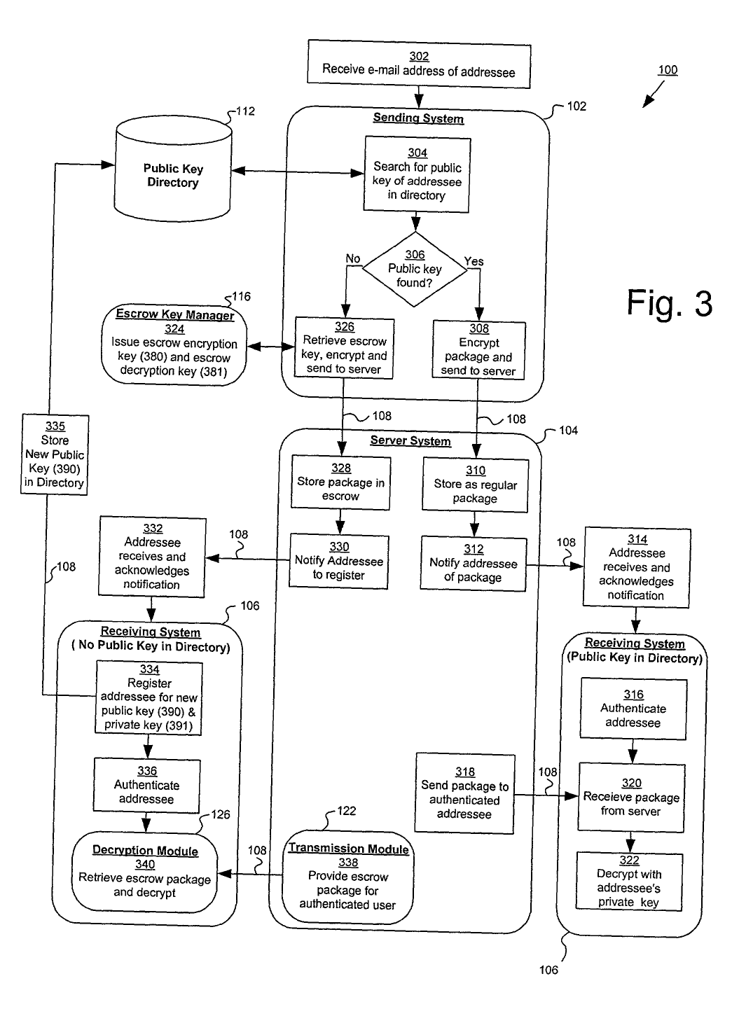

The server system 104 also includes a transmission module 122, the purpose of which is to transmit the package 10 from the storage area 118 to a decryption module 126 in the receiving system 106. In one embodiment, the transmission module 122 is a standard Web server running on the Windows NT® Server 4.0 or Windows 2000 Server, available from Microsoft Corporation. Additionally, the decryption module 126 may be implemented using a standard Web browser, such as the Microsoft Internet Explorer®, with decryption logic being contained within a plug-in or Java applet. Those skilled in the art, however, will recognize that various other transmission systems and methods could be used without departing from the spirit of the invention. Preferably, communication between the transmission and decryption modules 122, 126 is by HTTP using SSL and/or a VPN. Additionally, in one embodiment, the transmission module 122 is coupled to receive an addressee's public key 390 (see FIG. 3) from the directory 112 in order to authenticate the addressee 190, as described in greater detail below. In another embodiment, the transmission module 122 re-encrypts an escrowed package 10 or a package decryption key 601 using the public key 390 of the addressee 190.

The notification module 120 is coupled via the network 108 to a key registration module 124 in the receiving system 106. The key registration module 124 is configured to issue new public and private keys 390, 391 (see FIG. 3), to an addressee 190 who does not currently have such keys, and is additionally configured to automatically add the addressee's new public key 390 to the public key directory 112.

In one embodiment, the key registration module 124 is resident in the receiving system 106 before an information package 10 is sent by the sender 180. In an alternative embodiment, however, the notification module 120 is configured to send the key registration module 124 to the receiving system 106 as an attachment to an e-mail notification. In yet another embodiment, the e-mail notification includes a hyperlink, such as a Uniform Resource Locator (URL), which allows an addressee at a receiving system 106 to download the key registration module 124 using a conventional Web browser, such as the Netscape Communicator®, available from Netscape Communications Corporation of Mountain View, Calif.

As noted above, the receiving system 106 also includes a decryption module 126 for decrypting information packages 10. Like the encryption module 114, the decryption module 126 preferably uses a public key cryptosystem, available, for example, from RSA Security, Inc. However, in alternative embodiments, a symmetric key algorithm, such as the Data Encryption Standard (DES), may be used.

In one embodiment, the decryption module 126 is coupled to receive an escrow decryption key 381 (see FIG. 3) from the escrow key manager 116. Alternatively, the decryption module 126 is coupled to receive the addressee's private key 391 (see FIG. 3) from the key registration module 124. Using either the escrow decryption key 381 or the private key 391, the decryption module 126 decrypts the information package 10 and provides the decrypted package 10 to the addressee 190.

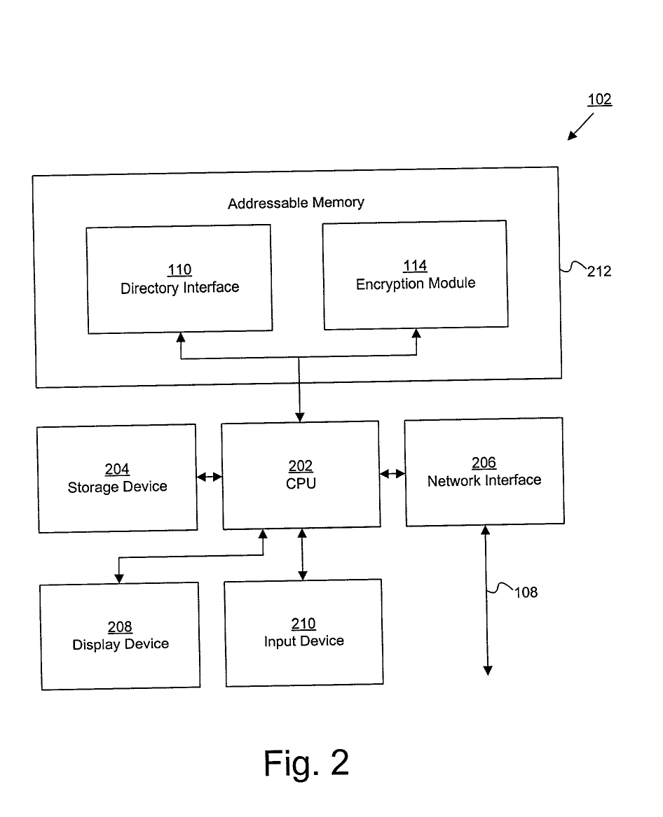

Preferably, the systems 102, 104, and 106 described above, as well as the public key directory 112 and escrow key manager 116, are each implemented using conventional personal computers or workstations, such as IBM® PC-compatible personal computers or workstations available from Sun Microsystems of Mountain View, Calif. For example, FIG. 2 is a physical block diagram showing additional implementation details of the sending system 102, and is similar in all relevant respects to other systems described above.

As illustrated in FIG. 2, a central processing unit (CPU) 202 executes software instructions and interacts with other system components to perform the methods of the present invention. A storage device 204, coupled to the CPU 202, provides long-term storage of data and software programs, and may be implemented as a hard disk drive or other suitable mass storage device. A network interface 206, coupled to the CPU 202, connects the sending system 102 to the network 108. A display device 208, coupled to the CPU 202, displays text and graphics under the control of the CPU 202. An input device 210, coupled to the CPU 202, such as a mouse or keyboard, facilitates user control of the sending system 102.

An addressable memory 212, coupled to the CPU 202, stores software instructions to be executed by the CPU 202, and is implemented using a combination of standard memory devices, such as random access memory (RAM) and read-only memory (ROM) devices. In one embodiment, the memory 212 stores a number of software objects or modules, including the directory interface 110 and encryption module 114 described above. Throughout this discussion, the foregoing modules are described as separate functional units, but those skilled in the art will recognize that the various modules may be combined and integrated into a single software application or device.

Referring now to FIG. 3, there is shown a flow diagram of the system 100 according to an embodiment of the present invention. Referring also to FIG. 1, the sending system 102 initially receives 302 from the sender the addressee's e-mail address. Although the addressee's e-mail address is used in one embodiment, those skilled in the art will recognize that the sender may specify an addressee 190 by name, which is associated, in the sending system 102, with an e-mail address or other unique identifier of the addressee 190. Although the addressee 190 is referred to hereafter in the singular, those skilled in the art will recognize that a package 10 may have a plurality of addressees.

After the e-mail address is received, the sending system 102 searches 304 the public key directory 112 using the addressee's e-mail address to locate the public key of the addressee 190. As noted earlier, this is accomplished by means of a directory interface 110 in the sending system 102, which accesses the directory 112 using a standard protocol such as LDAP.

A determination 306 is then made whether the addressee's key was found in the directory 112. If the key was found, the package 10 is encrypted 308 by the encryption module 114 using the addressee's public key and is sent to the server system 104, where it is stored 310 as a “regular” package. The term “regular” is used to distinguish the package 10 from one being stored in “escrow” for an addressee 190 who does not yet have a public key. In one embodiment, a separate storage area (not shown) in the server system 104 is provided for regular packages.

Next, the server system 104 notifies 312 the addressee 190 about the package 10 being stored for the addressee 190. As noted earlier, this is done, in one embodiment, by the notification module 120, which uses an e-mail notification system. However, those skilled in the art will recognize that other notification systems and methods could be used without departing from the spirit of the invention. For example, the receiving system 106 may include a notification client (not shown), which receives user datagram protocol (UDP) notifications from the notification module 120. Upon receipt of a UDP notification, the notification client generates a visual or audible desktop notification to the addressee, such as a blinking icon, a chime, a pop-up dialog box, or the like. Other forms of notification could include a voice notification via a voice synthesis module, a pager notification via a conventional pager, or a facsimile notification via a standard facsimile.

After the addressee 190 receives 314 the notification, the person claiming to be the addressee 190 is authenticated 316 to determine whether that person is, in fact, the addressee 190. Those skilled in the art will recognize that there are many ways to authenticate an addressee 190. For example, passwords or the like could be used.

Public key cryptography, however, provides a convenient and highly secures way for authenticating an addressee 190. In one embodiment, the addressee 190 encrypts a standard message using the addressee's private key and sends the encrypted message to the transmission module 122 in the server system 104. The transmission module 122 obtains the addressee's public key from the public key directory 112, and attempts to decrypt the message using the addressee's public key. If the message is successfully decrypted, the addressee is known to hold the private key corresponding to the public key in the directory 112 and is therefore authentic. Those skilled in the art will recognize that the above authentication steps may be performed automatically by a Web server and Web browser (or by custom software programs), with little active intervention required by the addressee 190. In another embodiment, the server system 104 is similarly authenticated by the receiving system 106.

After the addressee 190 is properly authenticated, the transmission module 122 sends 318 the package 10 via the network 108 to the receiving system 106, and the receiving system 106 receives 320 the package from the server 104. Those skilled in the art will recognize that either “push” or “pull” mechanisms could be used within the scope of the present invention. Preferably, secure channels such as VPN tunnels or SSL are used, although other standard protocols could also be used without departing from the spirit of the invention. When the package 10 is received, the decryption module 126 decrypts 322 the package 10 using the addressee's private key, and provides the decrypted package 10 to the addressee 190.

The foregoing discussion was in the context of the addressee's public key being found in the directory 112. However, a more difficult situation arises when the addressee's public key is not in the directory 112. Indeed, when the addressee 190 does not yet have a public key, conventional public key systems are wholly unable to send encrypted messages to the addressee. This represents a serious shortcoming of prior systems. The present invention solves this problem by holding the addressee's package 10 in escrow, as described in greater detail below.

Returning to step 306, if the addressee's public key was not found in the directory 112, the escrow key manager 116 issues 324, for the package 10, an escrow encryption key 380 and an escrow decryption key 381. The escrow encryption key 380 is used for encrypting the package 10 prior to being stored in escrow, and the escrow decryption key 381 is used for decrypting the package 10.

The escrow encryption/decryption keys 380, 381 should not be confused with the new public 390 and private keys 391 issued to the addressee 190, as described in step 334. If the escrow encryption/decryption keys 380, 381 were to be issued to the addressee 190, the decryption key 381 would need to be transmitted to the addressee 190 via the network 108, resulting in the same drawbacks as symmetric key cryptography. In public key cryptosystems, the addressee's private key 391 should never be sent to the addressee 190. Thus, in accordance with the present invention, the escrow encryption and decryption keys 380, 381 are not the same as the addressee's public and private keys 390 and 391, which are generated locally at the receiving computer 106 at step 334, and only the addressee's public key 390 is sent via the network 108 to the directory 112.

In one embodiment, the escrow encryption/decryption keys 380, 381 are asymmetric keys generated according to the RSA algorithm for key generation. Alternatively, the keys 380, 381 are a symmetric key or keys. In yet another embodiment, the keys 380, 381 are stored, not generated, by the escrow key manager 116, and are either hard-coded into the escrow key manager 116 or are added and periodically updated by an external agent or process. In still another embodiment, the public escrow key 380 is published in the directory 112, and the server system 104 keeps the private escrow key 381 in a hardware device that protects it from tampering, providing the highest level of security against tampering with the escrow keys.

After the keys 380, 381 are issued, the encryption module 114 within the sending system 102 retrieves 326 the escrow encryption key 380, encrypts the package 10 using the escrow encryption key 380, and sends the encrypted package 10 to the server system 104. The package 10 is then stored 328 in the storage area 118 as an “escrow” package or “escrow” delivery. As described hereafter, the server system 104 holds the package in escrow for the addressee 190 until the addressee 190 has properly registered and received new public and private keys 390, 391.

As in the case of a regular package, the addressee 190 is then notified 330 of the package 10 being stored in escrow and the need to register for public and private keys. In one embodiment, the notification is an e-mail message. Preferably, the notification message includes a copy of the key registration module 124 as an e-mail attachment. Preferably, the notification message including the key registration module 124 is digitally signed in order to verify the source of the message. In alternative embodiments, however, the notification includes a hyperlink, such as a URL, to permit the addressee to download the key registration module 124 from the server system 104 or another location.

After the addressee 190 has received 332 and acknowledged the notification and has either extracted or downloaded the key registration module 124, the addressee 190 uses the key registration module 124 to register 334 for new public and private keys 390, 391. As noted above, these keys 390, 391 are not the same as those issued by the escrow key manager 116. Preferably, the new public and private keys 390, 391 are generated according to the RSA algorithm for key generation, and are issued locally at the receiving system 106.

In one embodiment, the registration process is similar to the procedure used by VeriSign, Inc. and other certificate authorities to issue certificates, and involves prompting the addressee 190 for various personal data, including, for example, the addressee's name, address, telephone number, e-mail address, and the like. Those skilled in the art will recognize that various procedural safeguards may be used to increase the reliability of the data obtained from the addressee 190.

After the addressee 190 has registered, the addressee's new public key 390 is automatically transmitted via the network 108 and stored 335 in the public key directory 112. This is advantageous because a subsequent package 10 being sent to the same addressee 190 will be encrypted using the addressee's public key, providing a higher degree of security since no escrow keys are involved.

Next, the addressee 190 is authenticated 336 to determine whether the person claiming to be the addressee is, in fact, the addressee 190. As described previously with respect to step 316, authentication may involve encrypting a standard message at the receiving computer 106 using the addressee's private key 391, and decrypting the message at the server computer 102 using the addressee's public key 390 as obtained from the directory 112.

After the addressee 190 is authenticated, the transmission module 122 in the server system 104 sends 338 the package 10 for the authenticated addressee 190 to the decryption module 126 in the receiving system 106. The decryption module 126 then decrypts 340 the package 10 and provides the decrypted package 10 to the addressee 190. As described below, this process may be done in a number of ways.

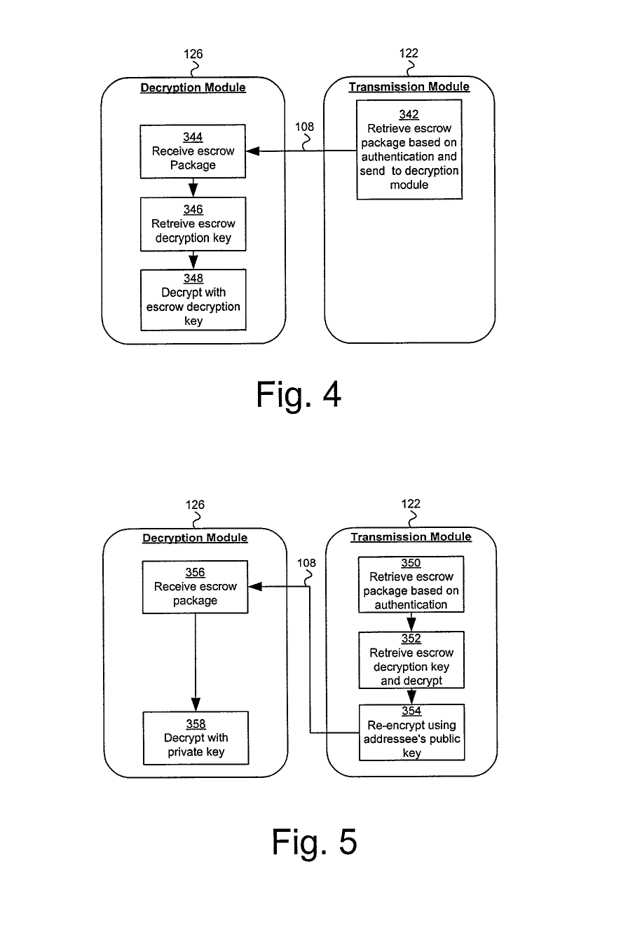

Referring now to FIG. 4, there is shown a first embodiment of the interaction between the transmission and decryption modules 122, 126. Initially, the transmission module 122 retrieves 342 the package 10 being stored in escrow for the authenticated addressee 190 and sends the package 10 via the network 108 to the decryption module 126, which receives 344 the package 10. Thereafter, the decryption module 126 retrieves 346 the escrow decryption key 381 for the package 10 from the escrow key manager 116. Using the escrow decryption key 381, the decryption module 126 then decrypts 348 the package 10.

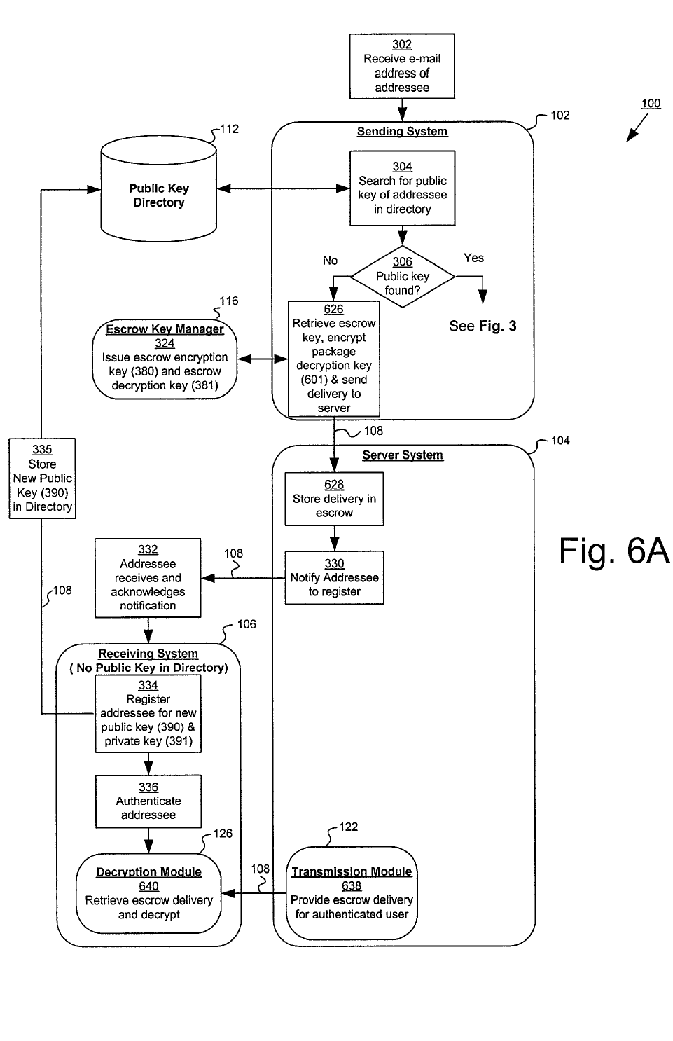

Referring now to FIG. 5, there is shown a second and more secure embodiment of the interaction between the transmission and decryption modules 122, 126. Initially, the transmission module 122 retrieves 350 the package 10 being stored in escrow for the authenticated user. Thereafter, the transmission module 122 retrieves 352 the escrow decryption key 381 from the escrow key manager 116, and decrypts the package 10 using the escrow decryption key 381. Next, the transmission module 120 re-encrypts 354 the package 10 using the addressee's new public key 390, which may be obtained from the directory 112 or the key registration module 124. After the package 10 is re-encrypted, it is sent via the network 108 to the decryption module 126, which receives 356 the package 10 and decrypts 358 the package 10 using the addressee's private key 391.

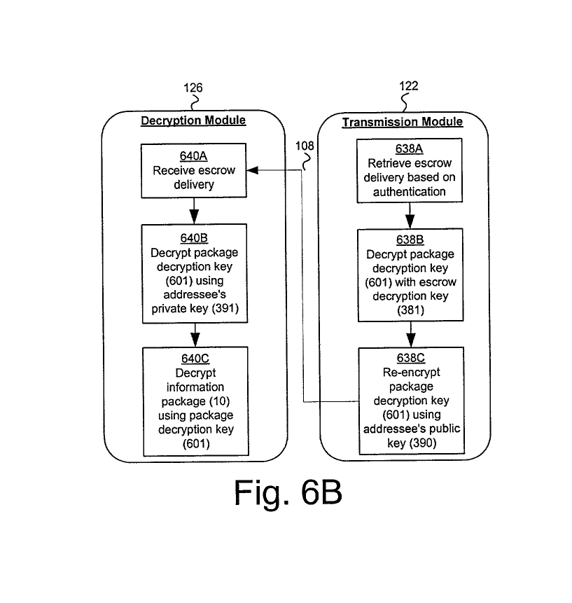

Referring now to FIG. 6A, there is shown an alternate embodiment of the present invention. The embodiment depicted in FIG. 6A is especially beneficial if the addressee's public key was not found in the public key directory 112. If the public key of the addressee 190 were located in the public key directory 112, handling and delivery of the information package 10 would proceed as described above and as depicted in FIG. 3.

Returning to step 306 of FIG. 6A, if the addressee's public key was not found in the directory 112, the escrow key manager 116 issues 324 an escrow encryption key 380 and an escrow decryption key 381. In one embodiment, the escrow encryption and decryption key pair 380, 381 is an asymmetric key pair generated according to the RSA algorithm for key generation. Alternatively, the keys 380, 381 are a symmetric key or keys. In yet another embodiment, the keys 380, 381 are stored, but not generated, by the escrow key manager 116, and are either hard-coded into the escrow key manager 116 or are added and periodically updated by an external agent or process. In still another embodiment, the public escrow key 380 is published in the directory 112, and the server system 104 keeps the private escrow key 381 in a hardware device that protects it from tampering, providing the highest level of security against tampering with the escrow keys.

After the escrow keys 380, 381 are issued, the encryption module 114 within the sending system 102 retrieves 626 the escrow encryption key 380. Instead of encrypting the package 10 with the escrow encryption key 380 as was done in the embodiments depicted in FIGS. 3-5, the sending system 102 uses a package encryption key 600 to encrypt the package 10, and uses the escrow encryption key 380 to encrypt a package decryption key 601. The package encryption key 600 is a key, preferably generated by the sending system 102, which the sending system 102 uses to encrypt the package 10. Preferably, the package encryption key 600 is a symmetric key (in which case the package encryption key 600 and the package decryption key 601 are the same key) because of its reduced time requirements needed for the encryption/decryption process as compared to asymmetric keys. But alternatively, the package encryption key 600 could be an asymmetric key. In the case of an asymmetric package encryption key 600, the sending system 102 will encrypt the package 10 with the package encryption key 600 and will include the package decryption key 601 as part of the delivery. In either case, the escrow encryption/decryption keys 380, 381 are used for encrypting the package decryption key 601 rather than encrypting/decrypting the package 10.

After the sending system 102 has encrypted the package 10 using the package encryption key 600 and has encrypted the package decryption key 601 using the escrow encryption key 380, the sending system 102 sends 626 a delivery to the server system 104. The delivery includes both of the encrypted items—the information package 10 which has been encrypted using the package encryption key 600, and the package decryption key 601 which has been encrypted using the escrow encryption key 380. The delivery is stored 628 in the storage area 118 as an “escrow” package or “escrow” delivery. As described above with respect to the other embodiments, the server system 104 holds the delivery in escrow for the addressee 190 until the addressee 190 has properly registered and received new public and private keys 390, 391.

As with the other embodiments described above, the addressee 190 is then notified 330 of the delivery being stored in escrow and the need to register for public and private keys 390, 391. In one embodiment, the notification is an e-mail message. Preferably, the notification message includes a copy of the key registration module 124 as an e-mail attachment. Preferably, the notification message including the key registration module 124 is digitally signed in order to verify the source of the message. In alternative embodiments, however, the notification includes a hyperlink, such as a URL, to permit the addressee to download the key registration module 124 from the server system 104 or another location.

After the addressee 190 has received 332 and acknowledged the notification and has either extracted or downloaded the key registration module 124, the addressee 190 uses the key registration module 124 to register 334 for new public and private keys 390, 391. As noted above, these keys 390, 391 are not the same as those issued by the escrow key manager 116. Preferably, the new public and private keys 390, 391 are generated according to the RSA algorithm for key generation, and are issued locally at the receiving system 106.

In one embodiment, the registration process is similar to the procedure used by VeriSign, Inc. and other certificate authorities to issue certificates, and involves prompting the addressee 190 for various personal data, including, for example, the addressee's name, address, telephone number, e-mail address, and the like. Those skilled in the art will recognize that various procedural safeguards may be used to increase the reliability of the data obtained from the addressee 190.

After the addressee 190 has registered, the addressee's new public key 390 is automatically transmitted via the network 108 and stored 335 in the public key directory 112. This is advantageous because subsequent deliveries being sent to the same addressee 190 will be encrypted using the addressee's public key 390, providing a higher degree of security since no escrow keys are involved.

Next, the addressee 190 is authenticated 336 to determine whether the person claiming to be the addressee is, in fact, the addressee 190. As described previously with respect to step 316, authentication may involve encrypting a standard message at the receiving computer 106 using the addressee's private key 391, and decrypting the message at the server computer 102 using the addressee's public key 390 as obtained from the directory 112.

After the addressee 190 is authenticated, the transmission module 122 in the server system 104 sends 638 the package 10 for the authenticated addressee 190 to the decryption module 126 in the receiving system 106. The decryption module 126 then decrypts 640 the package 10 and provides the decrypted package 10 to the addressee 190, which is described in more detail in the following paragraphs.

Referring now to FIG. 6B, there is shown an embodiment of the interaction between the transmission and decryption modules 122, 126. Initially, the transmission module 122 retrieves 638A the delivery being stored in escrow for the authenticated addressee 190. The transmission module 122 then uses the escrow decryption key 381 to decrypt 638B the package decryption key 601. The package decryption key 601 is then re-encrypted 638C using the addressee's public key 390. The delivery, which includes the encrypted information package 10 and the package decryption key 601 encrypted using the addressee's public key 390, is sent via the network 108 to the decryption module 126, which receives 640A the delivery. Thereafter, the decryption module 126 decrypts 640B the package decryption key 601 using the addressee's private key 391. Once the package decryption key 601 has been decrypted, the decryption module 126 then decrypts 640C the package 10 using the package decryption key 601.

In addition to solving the problem of securely delivering an information package to an addressee 190 who does not presently have encryption keys, the embodiment depicted in FIGS. 6A and 6B reduces the time delay caused by the encryption process. Encrypting and decrypting the information package 10 takes time. As the size of the information package 10 increases, the computing time necessary to encrypt it and decrypt it increases, and this time can become substantial. To remedy this problem, the escrow key or keys are used on a package decryption key 601 rather than used directly on the information package 10.

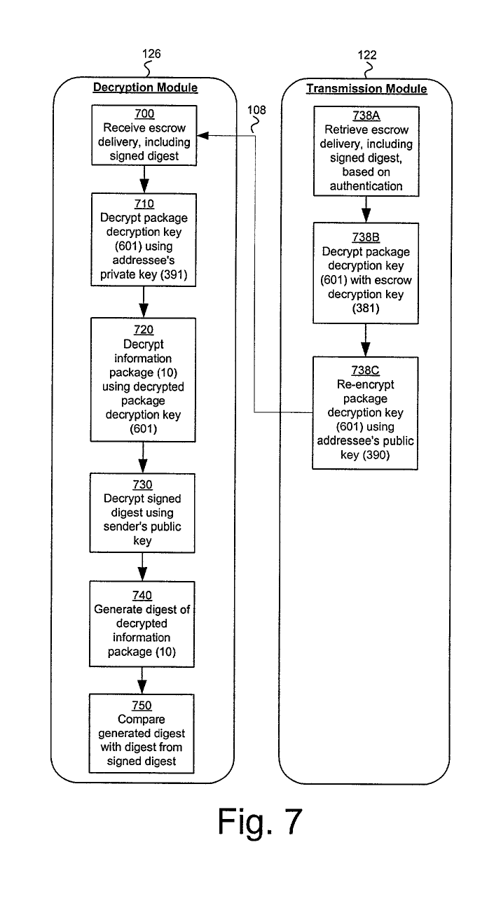

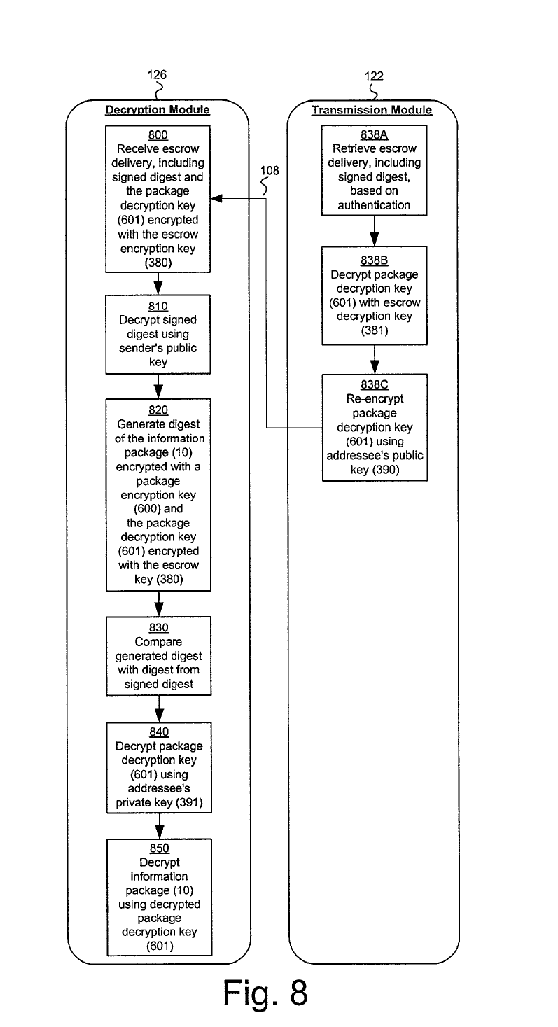

In alternate embodiments illustrated in FIGS. 7 and 8, the present embodiment can also include additional features, such as a digital signature and/or a message digest or hash. For example, the sending system 102 could include a digitally signed digest with the delivery. The signed digest allows the receiving system 106 to verify the identity of the originator of the delivery and to verify the integrity of the delivery. One skilled in the art will recognize that the steps described below can be performed in different sequence without deviating from the spirit of this invention, and that other digital signatures, digests, and signed digests can be included as part of the delivery.

To verify the origin and integrity of the delivery, the sending system 102 hashes some portion of the delivery. A hash algorithm is a method of transforming a variable length message into a fixed length number. This fixed length number is referred to as the hash, message digest, or digital fingerprint of the original message. For this message digest to be useful as part of a digital signature, the contents of the message must not be practically ascertainable from the message digest number. Thus, hash algorithms are typically one-way functions, which can easily generate a hash from a message, but which cannot, for all practical purposes, generate the original message given the hash. Well-known one-way hash algorithms that are useful for digital signing include MD2, MD5, and SHA-1.

Once a digest of some or all of the delivery has been generated, the digest, along with information about the hash algorithm used to generate the digest, is encrypted by the sending system 102 using the sender's private key. The sending system 102 includes this signed digest as part of the delivery to the server system 104. The receiving system 106 uses the sender's public key to decrypt the digest. The receiving system 106 can obtain the sender's public key by searching the public key directory 112. To verify the integrity of data, the decryption module 126 of receiving system 106 uses the same hash algorithm on the same portion of the received delivery. If the hash generated by the decryption module 126 does not match the decrypted hash, then this indicates a problem. Either the delivery did not originate from the sender 180 or the delivery was tampered with since the sending system 102 signed it. If the hashes match, the addressee 190 can be reasonably assured that the sender 180 sent the delivery and that it has not been modified.

Referring now to FIG. 7, there is shown an embodiment of the interaction between the transmission and decryption modules 122, 126 when a signed digest is included as part of the delivery. In this example, the signed digest included as part of the delivery by the sending system 102 is a digest of the information package 10 encrypted with the sender's private key. The transmission module 122 retrieves 738A the delivery from the storage area 118, which includes the signed digest. The transmission module 122 then uses the escrow decryption key 381 to decrypt 738B the package decryption key 601. The package decryption key 601 is then re-encrypted 738C using the addressee's public key 390. The delivery, which includes the encrypted information package 10, the package decryption key 601 encrypted using the addressee's public key 390, and the signed message digest, is sent via the network 108 to the decryption module 126, which receives 700 the delivery. Thereafter, the decryption module 126 decrypts 710 the package decryption key 601 using the addressee's private key 391. Once the package decryption key 601 has been decrypted, the decryption module 126 decrypts 720 the package 10 using the package decryption key 601. The decryption module 126 then decrypts 730 the signed digest using the sender's public key to obtain the digest. Decryption module 126 then uses the same hash algorithm as was used by the sending system 102 to generate 740 a digest of the decrypted package 10 which was obtained at step 720. Finally, the decryption module 126 compares 750 the digest it generated with the digest sent by the sending system 102. If the digests match, the receiving system 106 can be assured that the package 10 has not be altered and that the delivery originated from the sender. If the digests do not match, then the receiving system 106 knows that the delivery has been altered or did not originate from the sender 180.

Referring now to FIG. 8, there is shown an alternate embodiment of the interaction between the transmission and decryption modules 122, 126 when a different signed digest is included as part of the delivery. In this example, the signed digest included as part of the delivery by the sending system 102 is a digest of the information package 10 encrypted with the package encryption key 600 as well as the package decryption key 601 encrypted with the escrow encryption key 380—all of which is hashed and the digest obtained from the hash is encrypted with the sender's private key.

As depicted in FIG. 8, the transmission module 122 retrieves 838A the delivery from the storage area 118, which includes the signed digest, being stored in escrow for the authenticated addressee 190. The transmission module 122 then uses the escrow decryption key 381 to decrypt 838B the package decryption key 601. The package decryption key 601 is then re-encrypted 838C using the addressee's public key 390. The delivery, which includes the encrypted information package 10, the package decryption key 601 encrypted using the addressee's public key 390, the signed message digest, and the package decryption key 601 encrypted using the escrow encryption key 380, is sent via the network 108 to the decryption module 126, which receives 800 the delivery. Thereafter, the decryption module 126 decrypts 810 the signed digest using the sender's public key. The decryption module 126 of the receiving system 106 uses the same hash algorithm used by the sending system 102 to generate 820 a digest of the information package 10 encrypted by the package encryption key 600 and the package decryption key 601 encrypted with the escrow encryption key 380. The digest obtained at step 820 is compared 830 with the digest that was sent as part of the delivery and was decrypted at step 810 using sender's public key. If the digests do not match, then the receiving system 106 knows that the delivery has been altered or did not originate from the sender 180, and decryption module 126 need not decrypt the remaining portions of the delivery. If, however, the digests match, the receiving system 106 can be assured that the delivery has not be altered and that the delivery originated from the sender 180. The decryption module 126 proceeds to decrypt 840 the package decryption key 601 using the addressee's private key 391 and to decrypt 850 the information package 10 using the package decryption key 601.

The above description is included to illustrate the operation of the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A computer-implemented method for securely transmitting an information package from a sender to an addressee via a network, the method comprising a server system performing the steps of:
receiving a delivery from the sender, the delivery comprising:
the information package encrypted with a package encryption key; and
a package decryption key encrypted with an escrow key;
storing the delivery in escrow for the addressee;
sending to the addressee a notification of the delivery; and
in response to receiving an acknowledgement from the addressee:
obtaining a new public key of the addressee;
decrypting the package decryption key;
encrypting the package decryption key with the addressee's new public key; and
transmitting to the addressee the information package encrypted with the package encryption key and the package decryption key encrypted with the addressee's new public key.

2. The method of claim 1 further comprising the server system performing the steps of:
receiving a request from the sender for a public key of the addressee;
determining whether the addressee has a public key; and
in response to not finding a public key of the addressee:
transmitting the escrow key to the sender.

3. The method of claim 2 wherein the step of determining whether the addressee has a public key comprises the sub-step of:
checking a public key database for a public key of the addressee.

4. The method of claim 1 further comprising the server system performing the steps of:
in response to the sender searching a public key database for a public key of the addressee and not finding a public key of the addressee:
receiving a request from the sender for the escrow key; and
transmitting the escrow key to the sender.

5. The method of claim 1, further comprising the server system performing the steps of:
issuing the new public key to the addressee; and
storing the addressee's new public key in a public key database.

6. The method of claim 1, wherein the escrow key is one of a group comprising a symmetric key and an asymmetric key.

7. The method of claim 1, wherein the notification is one of a group comprising an e-mail notification, a desktop notification, a voice notification, a pager notification, and a facsimile notification.

8. The method of claim 1 further comprising the server system performing the steps of:
receiving from the sender a digest of one from a group comprising:
the information package;
the information package encrypted with the package encryption key; and
the information package encrypted with the package encryption key and the package decryption key encrypted with the escrow key; and
in response to receiving the acknowledgement from the addressee:
transmitting the digest to the addressee.

9. The method of claim 8, wherein the digest is encrypted by a private key of the sender.

10. The method of claim 1, wherein the acknowledgement from the addressee further comprises the step of authenticating the identity of the addressee.

11. A system for securely transmitting an information package from a sender to an addressee via a network, the system comprising:
a storage module, comprising a computer-readable storage medium, for receiving, and storing in escrow, a delivery from the sender, said delivery comprising:
a package decryption key encrypted with an escrow key, and
the information package encrypted with a package encryption key;
a notification module coupled to the storage module, for sending a notification to the addressee via the network;
a key registration module coupled to the notification module for, in response to receiving an acknowledgement from the addressee, receiving a new public key of the addressee; and
a transmission module coupled to the storage module, for decrypting the package decryption key and re-encrypting the package decryption key with the new public key of the addressee, and for transmitting to the addressee the information package encrypted with the package encryption key and the package decryption key encrypted with the addressee's new public key.

12. The system of claim 11 further comprising:
a directory interface coupled to the storage module for checking, in response to receiving a request from the sender for a public key of the addressee, a public key database for the public key of the addressee; and
an escrow key manager coupled to the directory interface for providing, in response to the directory interface failing to obtain a public key of the addressee from the public key database, an escrow key for encrypting the package decryption key.

13. The system of claim 11, wherein the key registration module also stores the addressee's new public key in a public key database.

14. The system of claim 11, further comprising:
a public key database coupled to the directory interface for storing a public key of at least one addressee.

15. The system of claim 11, wherein the escrow key comprises one from a group comprising a symmetric key and an asymmetric key.

16. The system of claim 11, wherein the notification is one of a group comprising an e-mail notification, a desktop notification, a voice notification, a pager notification, and a facsimile notification.

17. The system of claim 11 further comprising:
an authentication module coupled to the notification module for authenticating the addressee prior to transmitting the information package encrypted with the package encryption key and the package decryption key encrypted with the addressee's new public key.

18. A computer-readable medium comprising computer program code for securely transmitting an information package from a sender to an addressee via a network, the computer program code adapted to perform the steps of:
receiving a delivery from the sender, the delivery comprising:
the information package encrypted with a package encryption key; and
a package decryption key encrypted with an escrow key;
storing the delivery in escrow for the addressee;
sending to the addressee a notification of the delivery; and
in response to receiving an acknowledgement from the addressee:
obtaining a new public key of the addressee;
decrypting the package decryption key;
encrypting the package decryption key with the addressee's new public key; and
transmitting to the addressee the information package encrypted with the package encryption key and the package decryption key encrypted with the addressee's new public key.

19. The computer-readable medium of claim 18 further comprising program code adapted to perform the steps of:
receiving a request from the sender for a public key of the addressee;
determining whether the addressee has a public key; and
in response to not obtaining a public key of the addressee:
transmitting the escrow key to the sender.

20. The computer-readable medium of claim 19, further comprising program code adapted to perform the step of:
checking a public key database for the public key of the addressee.

21. The computer-readable medium of claim 18, further comprising program code adapted to perform the steps of:
in response to the sender searching a public key database for a public key of the addressee and not obtaining said public key:
receiving a request from the sender for the escrow key; and
transmitting the escrow key to the sender.

22. The computer-readable medium of claim 18, further comprising program code adapted to perform the steps of:
issuing the new public key to the addressee; and
storing the addressee's new public key in a public key database.

23. The computer-readable medium of claim 18, wherein the notification is one of a group comprising an e-mail notification, a desktop notification, a voice notification, a pager notification, and a facsimile notification.

24. The computer-readable medium of claim 18, further comprising program code adapted to perform the steps of:
receiving from the sender a digest of one from a group comprising:
the information package;
the information package encrypted with the package encryption key; and
the information package encrypted with the package encryption key and the package decryption key encrypted with the escrow key; and
in response to receiving the acknowledgement from the addressee:
transmitting the digest to the addressee.

25. The method of claim 23, wherein the digest is encrypted by a private key of the sender.

26. The computer-readable medium of claim 18, further comprising program code adapted to perform the step of:
authenticating the addressee prior to transmitting the information package encrypted with the package encryption key and the package encryption key encrypted with the addressee's new public key.
